(19) United States
(12) Patent Application Publication
(10) Pub. No.: US 2014/0074906 A1
(43) Pub. Date: Mar. 13, 2014

(54) INFORMATION PROCESSING APPARATUS, SYSTEM, AND METHOD

(71) Applicants: Zhi MIN, Tokyo (JP); Sachiko Takeuchi, Tokyo (JP)

(72) Inventors: Zhi MIN, Tokyo (JP); Sachiko Takeuchi, Tokyo (JP)

(73) Assignee: RICOH COMPANY, LTD., Tokyo (JP)

(21) Appl. No.: 14/016,322

(22) Filed: Sep. 3, 2013

(30) Foreign Application Priority Data
Sep. 10, 2012 (JP) 2012-198651

(51) Int. Cl. H04L 29/08

(52) U.S. Cl. CPC H04L 67/10
USPC 709/201

(57) ABSTRACT

An information processing apparatus includes a receiving part that receives, via a network, a processing request for a process to be performed on management information, an execution time estimating part that estimates an execution time of the process to be performed on the management information, and a selection part that selects a notification method for notifying an execution result of the process to be performed on the management information based on a comparison result of comparing the estimated execution time with a predetermined threshold value.

### BACKGROUND OF THE INVENTION

1. Field of the Invention

The disclosures herein relate to an information processing apparatus, system, and method.

2. Description of the Related Art

User information management apparatuses are known that are configured to generate notification information relating to an update of registration information of a group management database when a user registration update is made with respect to a group, and automatically send the generated notification information to users already registered in the group management database (See e.g., Japanese Laid-Open Patent Publication No. 2001-75887).

Recently, system applications that provide services using a server, as exemplified by a cloud service, are becoming widespread. In such system applications, management information such as user information is managed on a server. However, there are times when processes such as addition, updating, or deletion that are executed in batches on management information that is managed on a server cannot be completed within a short period of time.

When a batch process on management information that is managed on a server cannot be completed within a short period of time, an administrator that has requested the execution of such a batch process may have to wait for a long period of time to obtain the processing result and the administrator may be greatly burdened by such a delay.

### SUMMARY OF THE INVENTION

It is a general object the present invention to provide an information processing apparatus, system, and method that substantially remedy one or more problems caused by the limitations and disadvantages of the related art.

According to one embodiment of the present invention, an information processing apparatus includes a receiving part that receives, via a network, a processing request for a process to be performed on management information, an execution time estimating part that estimates an execution time of the process to be performed on the management information, and a selection part that selects a notification method for notifying an execution result of the process to be performed on the management information based on a comparison result of comparing the estimated execution time with a predetermined threshold value.

According to an aspect of the present invention, the burden on an administrator that makes a processing request for a process to be executed in a batch on management information may be reduced.

### BRIEF DESCRIPTION OF THE DRAWINGS

FIG. 1 illustrates an exemplary configuration of a system according to an embodiment of the present invention;

FIG. 2 illustrates an exemplary hardware configuration of a computer system according to an embodiment of the present invention;

FIG. 3 is a block diagram illustrating exemplary process blocks of a service providing system according to an embodiment of the present invention;

FIG. 4 illustrates an exemplary configuration of company management information;

FIG. 5 illustrates an exemplary configuration of user management information;

FIG. 6 illustrates an exemplary configuration of device management information;

FIG. 7 illustrates an exemplary image of an administrator function screen;

FIG. 8 illustrates an exemplary image of a batch management screen;

FIG. 9 illustrates an exemplary configuration of a CSV file that may be selected from a file selection box;

FIG. 10 is a flowchart illustrating exemplary process steps of a process implemented by a batch management function;

FIG. 11 is a flowchart illustrating exemplary process steps of a determination process for determining a user to be notified of a batch management operation result; and

FIG. 12 illustrates an exemplary configuration of a notification rule table.

### DESCRIPTION OF THE PREFERRED EMBODIMENTS

In the following, embodiments of the present invention are described with reference to the accompanying drawings.

<System Configuration>

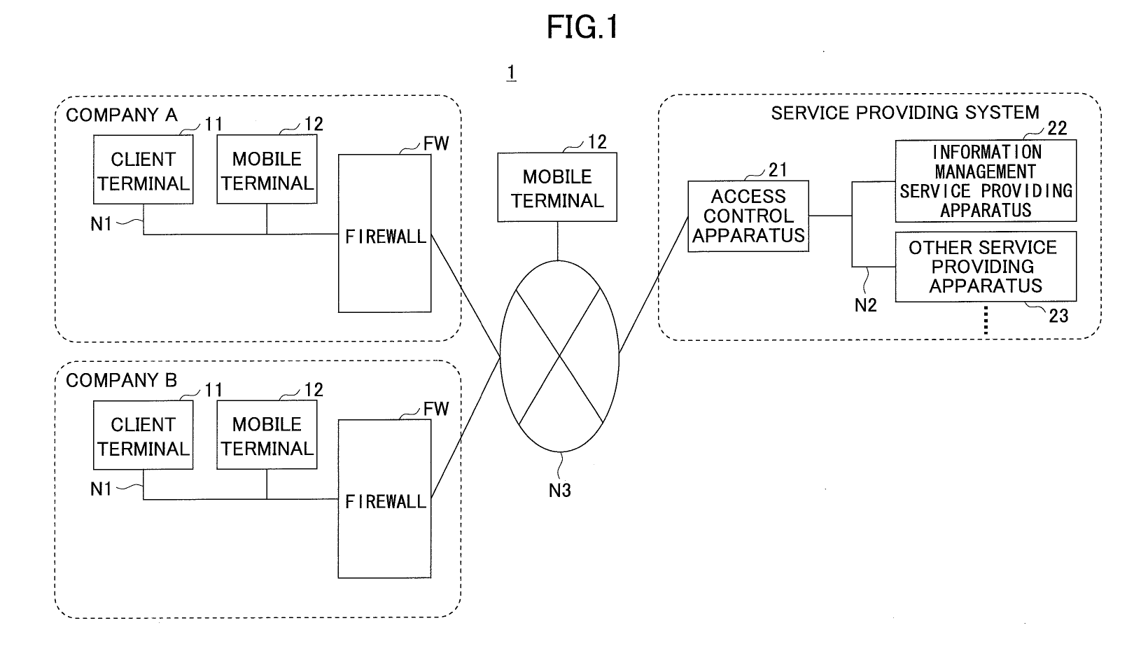

FIG. 1 illustrates an exemplary configuration of a system 1 according to an embodiment of the present invention. The system 1 illustrated in FIG. 1 includes a private network N1 such as an intranet, a public network N2 such as a cloud service, and a network N3 such as the Internet.

The network N1 and the network N3 are connected by a firewall FW at the network N1 side. The firewall FW is located at a connection point between the network N1 and the network N3 and is configured to link access from the network N1 to the network N3.

Also, the network N2 and the network N3 are connected by an access control apparatus 21 at the network N2 side. The access control apparatus 21 is configured to ensure the security of the network N2.

The network N1 is a private network that is located within the firewall FW. A client terminal 11 and a mobile terminal 12 are connected to the network N1.

The client terminal 11 is an embodiment of a terminal apparatus. The client apparatus 11 may be an information processing apparatus (computer system) having a general OS (operating system) installed therein. The client terminal 11 includes means for establishing wireless or wired communication. For example, the client terminal 11 may be a tablet PC, a notebook PC, or some other type of terminal apparatus that may be operated by an administrator.

The mobile terminal 12 is another embodiment of a terminal apparatus. The mobile terminal apparatus 12 includes means for establishing wireless or wired communication. For example, the mobile terminal 12 may be a smart phone, a cell phone, a tablet PC, a notebook PC, or some other type of terminal apparatus that may be operated by an administrator. The mobile terminal 12 may alternatively be connected to the network N3 such as the Internet.

Note that although one client apparatus 11 and one mobile terminal 12 are connected to the network N1 in the example illustrated in FIG. 1, more than one client apparatus 11 and/or more than one mobile terminal 12 may be connected to the network N1.

The network N2 is connected to the network N3 such as the Internet via the access control apparatus 21. The access control apparatus 21, an information management service providing apparatus 22, and another service providing apparatus 23 are connected to the network N2. In the system 1 illustrated in FIG. 1, the access control apparatus 21, the information management service providing apparatus 22, and the other service providing apparatus 23 embody a service providing system.

The access control apparatus 21 controls access to various services including an information management service provided by the information management service providing apparatus 22. The information management service providing apparatus 22 provides the information management service. The other service providing apparatus 23 provides some other type of service. The access control apparatus 21, the information management service providing apparatus 22, and the other service providing apparatus 23 may be implemented by one or more information processing apparatuses (computer systems).

In certain embodiments, functions of the information management service providing apparatus 22 and the other service providing apparatus 23 of the system 1 illustrated in FIG. 1 may be consolidated in a single computer, or they may alternatively be implemented by a number of computers. Also, certain functions implemented at the service providing system side of the system 1 illustrated in FIG. 1 may be implemented at the network N1 side. Further, the client terminal 11 and/or the mobile terminal 12 may be connected to a network other than the network N1.

The administrator of the system 1 may perform operations such as addition, updating, and deletion of management information such as user information that is managed at the service providing system side. The information management service providing apparatus 22 may notify the administrator of the operation result (execution result) of the operation executed on the management information by transmitting the operation result to the client terminal 11.

The information management service providing apparatus 22 includes a batch management function for accepting operations such as addition, updating, or deletion of management information in a batch from the administrator and executing corresponding processes such as addition, updating, or deletion on the management information. For example, the batch management function may be used to perform batch registration of all employee users when starting a service, to change the e-mail addresses of all users in response to a change in the domain name of the e-mail addresses, or to additionally register new employee users that have been collectively hired.

The batch management function accepts operations such as addition, updating, or deletion of management information in a batch from the administrator by a file such as a CSV (comma-separated values) file describing the processes to be implemented, and executes the processes such as addition, updating, or deletion of the management information in a batch based on the file.

When operations such as addition, updating, or deletion of management information are accepted in a batch by the batch management function, the information management service providing apparatus 22 estimates the time required before the administrator may be notified of the result of the operation on the management information and determines a notification method for notifying the administrator of the operation result. When the estimated time required before being able to notify the administrator of the operation result is longer than a predetermined time period, the information management service providing apparatus 22 may notify the administrator of the operation result by email, for example. On the other hand, if the estimated time required before being able to notify the administrator of the operation result is shorter than the predetermined time period, the information management service providing apparatus 22 may notify the administrator of the operation result by displaying the operation result on a webpage screen providing the batch management function, for example.

Thus, when the time required before the administrator may be notified of the result of operations on management information is longer than a predetermined time period, the administrator does not have to wait for the operation result to be displayed on the webpage screen providing the batch management function and may instead be notified by email of the operation result. In this way, the burden on the administrator may be reduced.

<Hardware Configuration>

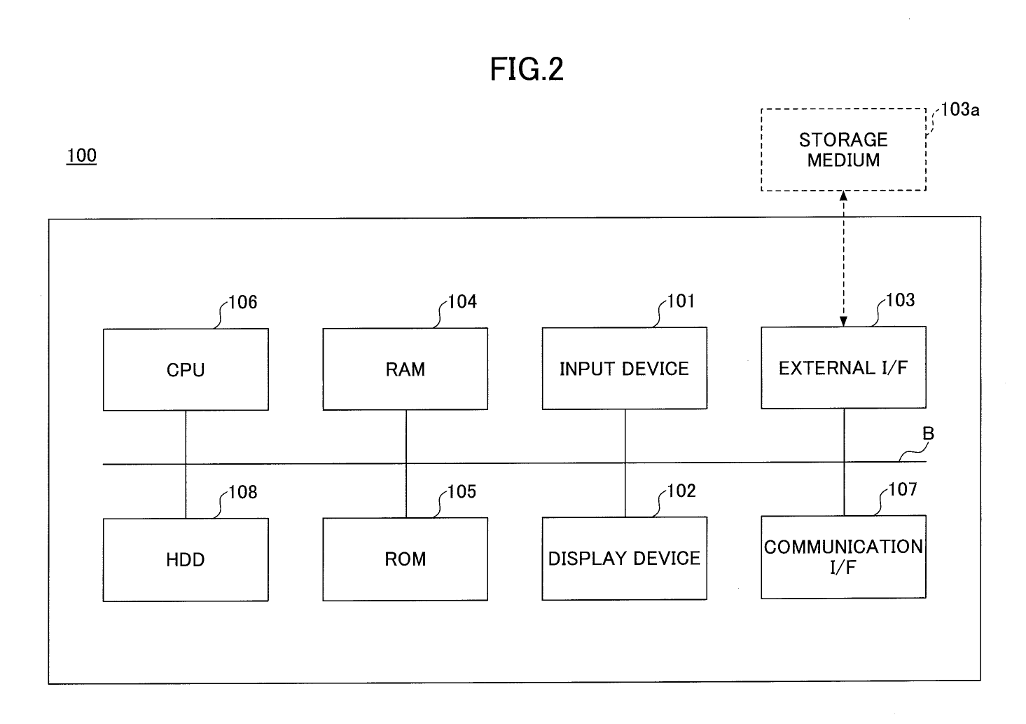

The client terminal 11, the mobile terminal 12, the access control apparatus 21, the information management service providing apparatus 22, and the other service providing apparatus 23 illustrated in FIG. 1 may be implemented by a computer system having a hardware configuration as illustrated in FIG. 2, for example. FIG. 2 illustrates an exemplary hardware configuration of a computer system 100 according to an embodiment of the present invention.

The computer system 100 illustrated in FIG. 2 includes an input device 101, a display device 102, an external I/F (interface) 103, a RAM (random access memory) 104, a ROM (read only memory) 105, a CPU (central processing unit) 106, a communication I/F 107, and a HDD (hard disk drive) 108 that are interconnected via a bus B.

The input device 101 may include a keyboard, a mouse, and a touch panel, for example, and is used to input various operation signals. The display device 102 may include a display that displays processing results of the computer system 100, for example.

The communication I/F 107 is an interface that connects the computer system 100 to the network N1 or N2. In this way, the computer system 100 may establish communication with external systems and devices via the communication I/F 107.

The HDD 108 is a nonvolatile storage device that stores programs and data. For example, the HDD 108 may store an OS (operating system) including basic software for controlling overall operations of the computer system 100 and application software that is run on the OS to implement various functions of the computer system 100. The HDD 108 includes a file system and/or a DB (database) for managing the programs and data stored therein.

The external I/F 103 is an interface with an external device. The external device includes a storage medium 103a, for example. The computer system 100 may read/write data from/on the storage medium 103a via the external I/F 103. The storage medium 103a may be any computer-readable media except for a transitory propagating signal. For example, the storage medium 103a may be a flexible disk, a CD (compact disk), a DVD (digital versatile disk), a SD memory card, or a USB (universal serial bus) memory.

The ROM 105 is a nonvolatile semiconductor memory (storage device) that is capable of retaining data and programs even when the power of the computer system 100 is turned off. The ROM 105 stores programs and data such as BIOS (basic input/output system) that is executed upon starting the computer system 100, OS settings, and network settings. The RAM 104 is a volatile semiconductor memory (storage device) that temporarily stores programs and data.

The CPU 106 reads the programs and data stored in the ROM 105 and the HDD 108 and loads the programs and data on the RAM 104 to execute various processes. In this way, the CPU 106 implements various functions and controls overall operations of the computer system 100.

By configuring the client terminal 11, the mobile terminal 12, the access control apparatus 21, the information management service providing apparatus 22, and the other service providing apparatus 23 to have the above-described hardware configuration of the computer system 100, various functions and processes of the system 1 may be implemented as described below.

<Software Configuration>

<<Service Providing System>>

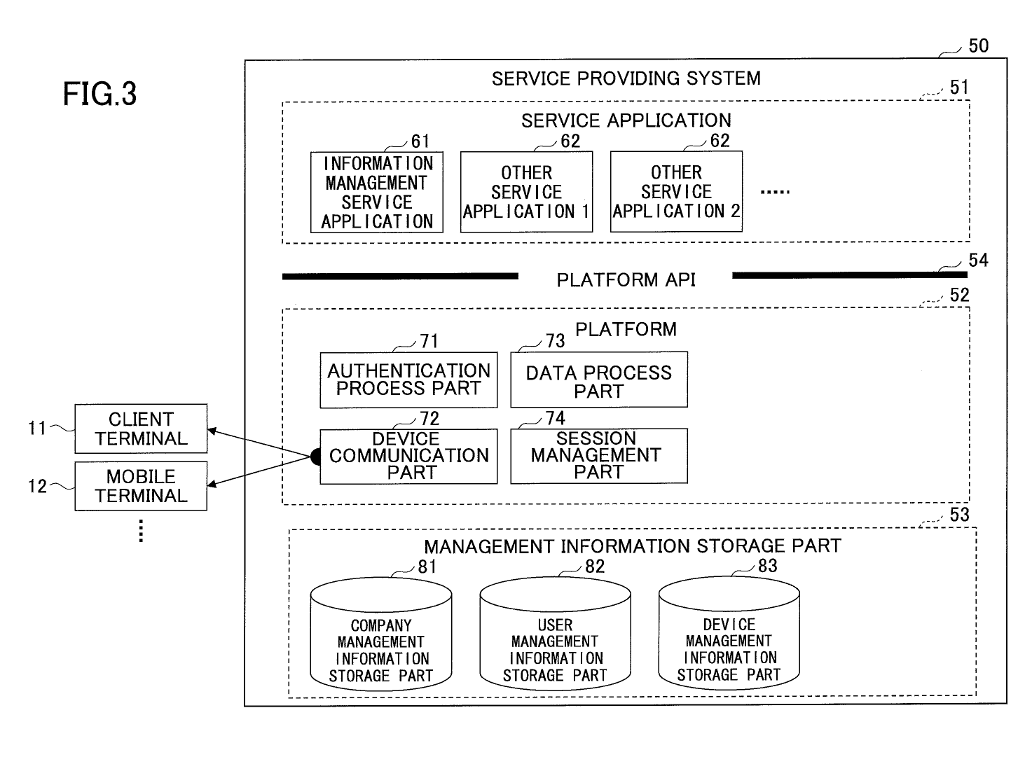

A service providing system according to an embodiment of the present invention may have software components as illustrated in FIG. 3, for example. FIG. 3 illustrates exemplary process blocks of a service providing system 50 according an embodiment of the present invention. The service providing system 50 illustrated in FIG. 3 executes a corresponding program to implement a service application 51, a platform 52, a management information storage part 53, and a platform API (Application Programming Interface) 54.

In the example illustrated in FIG. 3, the service application 51 includes an information management service application 61 and at least one other service application 62. The information management service application 61 is an application that provides an information management service. The other service application 62 is an application that provides some other type of service.

The platform API 54 is an interface that enables the service application 51 such as the information management service application 61 and the other service application 62 to use the platform 52. The platform API 54 is a pre-defined interface that is provided to enable the platform 52 to receive a request from the service application 51 and may include functions and classes, for example. In certain embodiments where the service providing system 50 is implemented by more than one information processing apparatuses, the platform API 54 may be a web API that may be used via a network, for example.

The platform 52 illustrated in FIG. 3 includes an authentication process part 71, a device communication part 72, a data process part 73, and a session management part 74. The authentication process part 71 performs authentication based on a login request from the client terminal 11 or the mobile terminal 12.

The device communication part 72 establishes communication with the client terminal 11 or the mobile terminal 12. The data process part 73 executes a data process based on a request from the service application 51. The session management part 74 manages a session with the client terminal 11 or the mobile terminal 12.

The management information storage part 53 includes a company management information storage part 81, a user management information storage part 82, and a device management information storage part 83. The company management information storage part 81 stores company management information (described below). The user management information storage part 82 stores user management information (described below). The device management information storage part 83 stores device management information (described below).

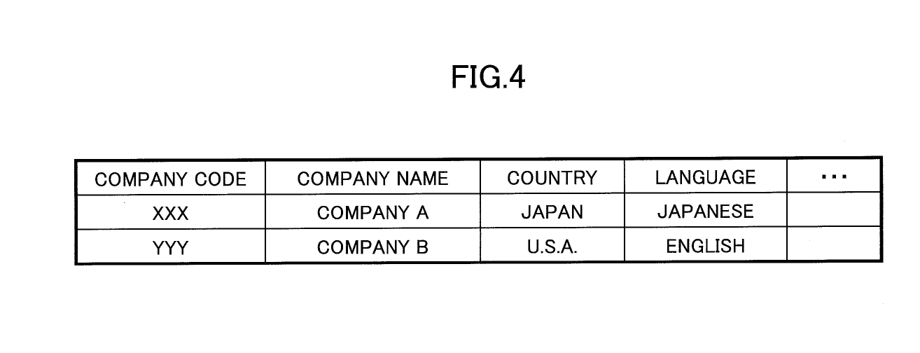

FIG. 4 illustrates an exemplary configuration of the company management information. The company management information illustrated in FIG. 4 includes data items such as company code, company name, country, and language, for example. The company code corresponds to information uniquely identifying a group such as a company or an organization.

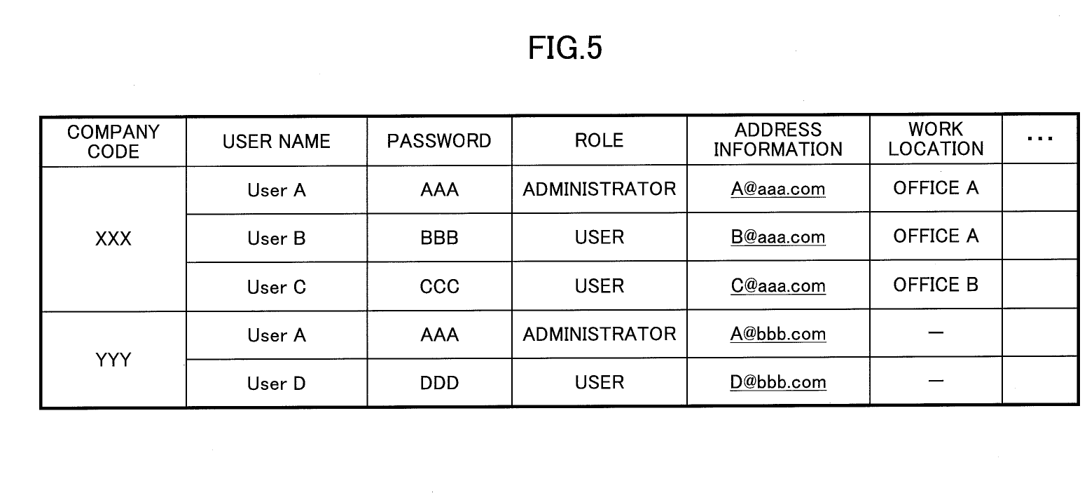

FIG. 5 illustrates an exemplary configuration of the user management information. The user management information illustrated in FIG. 5 includes data items such as company code, user name, password, role, address information, and primary work location, for example. Note that although a user name and password associated with a certain company code has to be unique, user names and passwords may overlap when they are associated with different company codes.

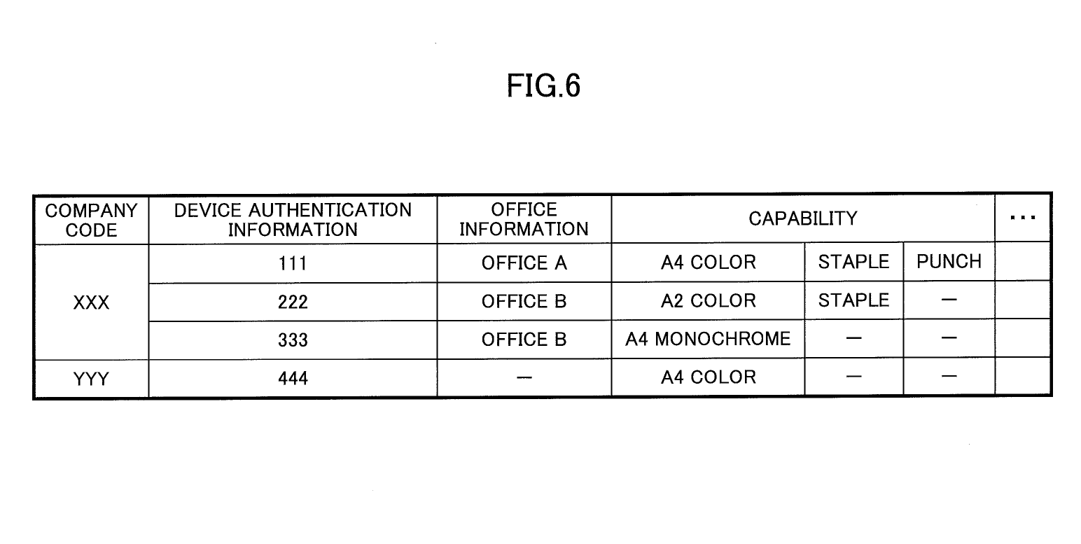

FIG. 6 illustrates an exemplary configuration of the device management information. The device management information illustrated in FIG. 6 includes data items such as company code, device authentication information, office information, and capability, for example. The device management information is managed based on company code. The device authentication information is used for authenticating a device by determining that an office device such as an imaging device (not shown) satisfies certain conditions. For example, the device authentication information may be an ID indicating that a certain application is installed or a device number indicating that the device is a certain type of device.

The company management information, the user management information, and the device management information illustrated in FIGS. 4-6 are examples of management information on which operations such as addition, updating, and deletion may be executed by the batch management function.

<Processes>

In the following, processes of the system 1 according to the present embodiment are described in detail.

<<Login Process>>

For example, the administrator may attempt to access an information management service of the service providing system 50 by operating the client terminal 11. The client terminal 11 displays a login screen. The administrator enters authentication information such as a company code, a user name, and a password into the login screen.

After entering the authentication information into the login screen, the administrator presses a login button. When the login button is pressed, the client terminal 11 makes a login request by sending the authentication information to the service providing system 50. In turn, the authentication process part 71 of the service providing system 50 performs a login process based on the authentication information received from the client terminal 11.

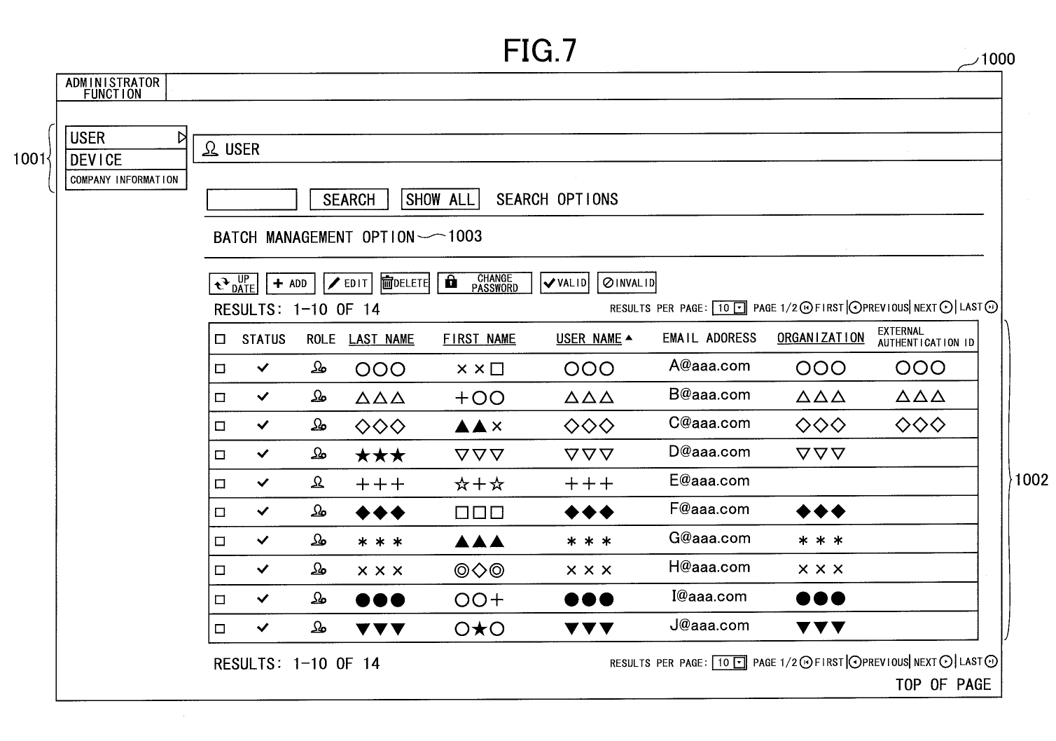

If the login process is successful, the information management service application 61 may prompt the client terminal 11 to display an administrator function screen 1000 as illustrated in FIG. 7, for example.

<<Operation of Batch Management Function>>

FIG. 7 illustrates an exemplary image of the administrator function screen 1000. The information management service application 61 controls the client terminal 11 to switch screens displayed on the administrator function screen 1000 according to operations of the administrator as described in detail below.

In the administrator function screen 1000 illustrated in FIG. 7, “user” is selected from a side menu 1001, and a user list 1002 is displayed on the administrator function screen 1000 accordingly. When “device” is selected from the side menu 1001, a device list may be displayed on the administrator function screen 1000. When “company information” is selected from the side menu 1001, a company information screen may be displayed on the administrator function screen 1000.

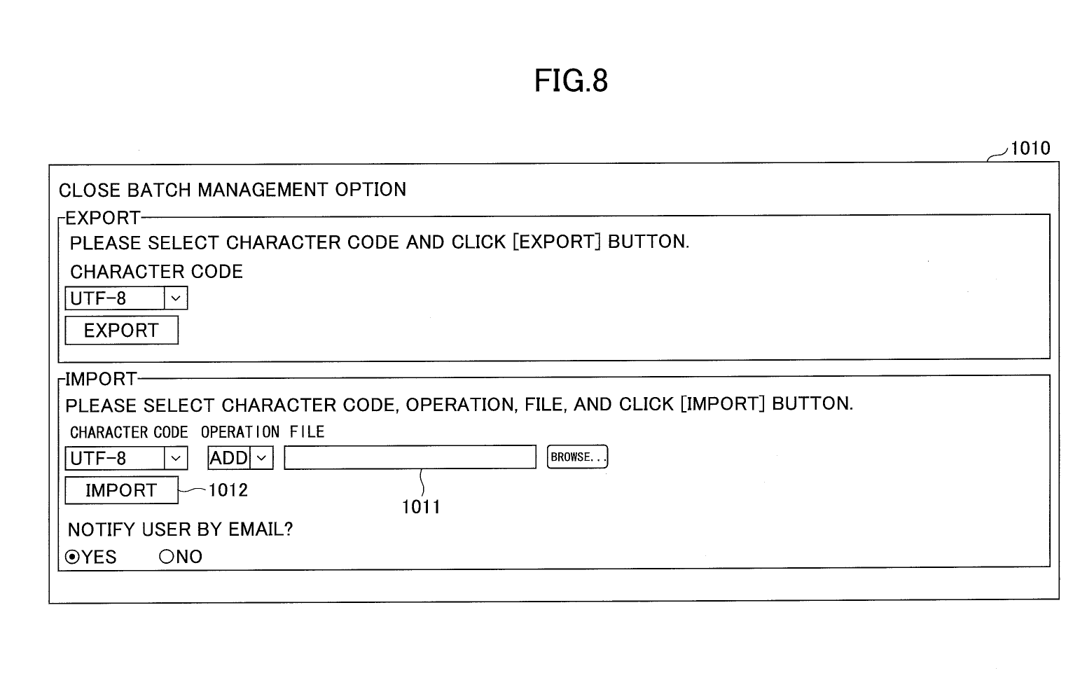

When a batch management option 1003 is selected, the information management service application 61 prompts the client terminal 11 to display a batch management screen 1010 as illustrated in FIG. 8, for example. FIG. 8 illustrates an exemplary image of the batch management screen 1010.

To use the batch management function, the administrator selects from a file selection box 1011 a file such as a CSV file describing an operation such as addition, updating, or deletion to be implemented with respect to management information. After selecting a file from the file selection box 1011, the administrator may press an import button 1012 to start process operations of the batch management function.

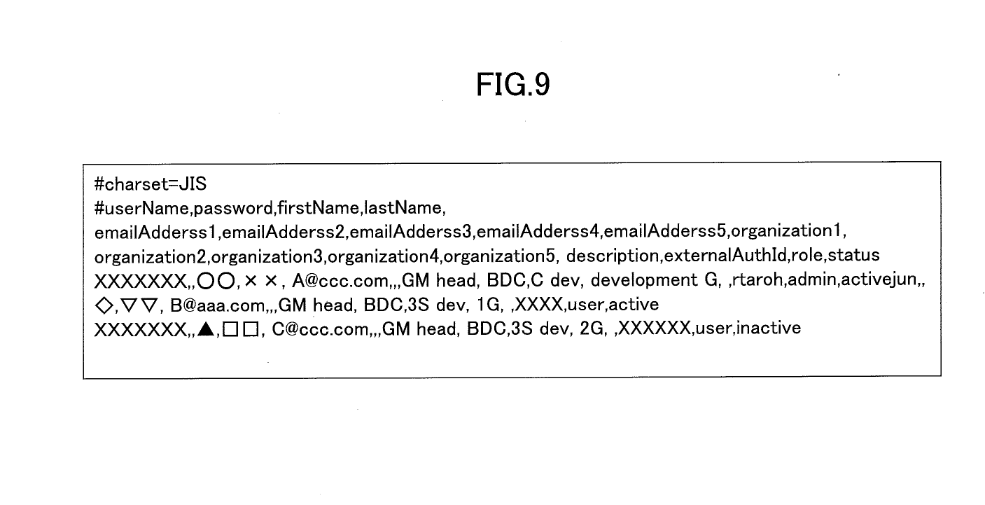

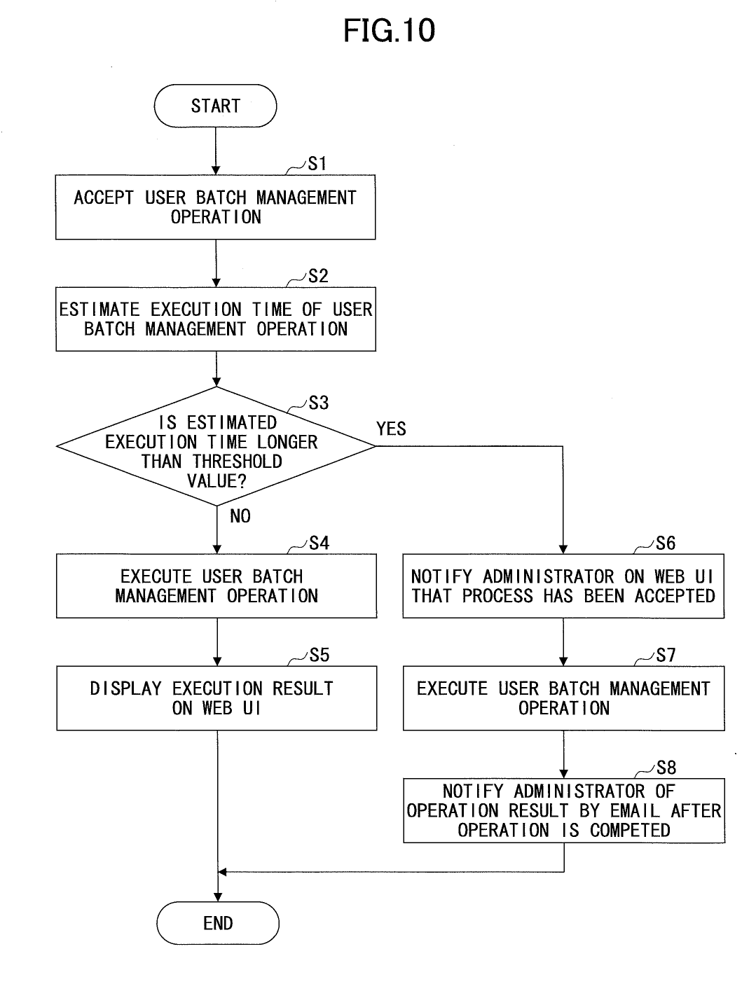

FIG. 9 illustrates an exemplary configuration of a CVS file that may be selected from the file selection box 1011. FIG. 9 illustrates a CVS file that describes an operation to be implemented on user management information as an example. When the import button 1012 is pressed, the information management service application 61 of the service providing system 50 may refer to the file such as the CSV file describing the operations to be implemented on management information and execute the operations such as addition, updating, or deletion of the management information. For example, the information management service application 61 may execute the process steps as illustrated in FIG. 10.

<<Process of Management Function>>

In the following, batch processing operations on the user management information of the management information is described as an example with reference to FIG. 10. FIG. 10 is a flowchart illustrating exemplary process steps of a process implemented by the batch management function.

In step S1, the information management service application 61 accepts a user batch management operation from the client terminal 11. In step S2, the information management service application 61 estimates the required execution time for executing the user batch management operation.

Note that various methods may be used to estimate the required execution time for executing the user batch management operation. For example, as a first method, the execution time may be estimated based on an average processing time per user of the service providing system 50 and the number of users to be managed in the user batch management operation.

As a second method, instead of using the average processing time per user of the service providing system 50, an average processing time per user for a given company or a given time range may be used to estimate the execution time. As a third method, the execution time may be estimated based on the number of users to be managed by the user batch management operation.

In step S3, the information management service application 61 determines whether the execution time for executing the user batch management operation estimated in step S2 is longer than a predetermined threshold value. The threshold value may be an estimated maximum time period that may be tolerated by the administrator waiting for the operation result of the user batch management operation to be displayed on the administrator function screen 1000 without feeling inconvenienced by the waiting time, for example.

If the execution time for executing the user batch management operation estimated in step S2 is not longer than the threshold value, the information management service application 61 proceeds to step S4. In step S4, the information management service application 61 refers to a file such as a CSV file describing the operation to be executed on the user management information and prompts the data process part 73 to execute the user batch management operation based on the file, for example.

After executing the user batch management operation in step S4, the information management service application 61 notifies the administrator of the result of the user batch management operation via a webpage screen (web UI) in step S5. The result of the user batch management operation may be displayed on the administrator function screen 1000 or in a dialog box, for example.

For example, the result of the user batch management operation may be displayed as a message as follows: “Batch process operation has been completed. Below is the processing result. Process: addition; Successful results: 200; File name: hoge.csv.”

On the other hand, if it is determined in step S3 that the execution time for executing the user batch management operation estimated in step S2 is longer than the threshold value, the information management service application 61 proceeds to step S6. In step S6, the information management service application 61 notifies the administrator on a webpage screen that the user batch management operation has been accepted. The message indicating that the user batch management operation has been accepted may be displayed on the administrator function screen 1000 or in a dialog box, for example.

For example, the message indicating that the user batch management operation has been accepted may read as follows: “Import process has been accepted. The execution result will be sent to your email address as soon as the import process is completed.”

In another example, the message indicating that the user batch management operation has been accepted may read as follows: “The batch process has been started. The required processing time is approximately 20 minutes. The processing result will be sent by email after completion of the process. *Note: depending on the number of processes and execution environment, the processing time may take longer than indicated.”

In step S7, the information management service application 61 refers to the file describing the operation to be executed on the user management information and prompts the data process part 73 to execute the user batch management operation based on the file, for example.

After executing the user batch management operation in step S7, the information management service application 61 notifies the administrator of the result of the user batch management operation by email in step S8. For example, the email may include a message that reads as follows: “Batch process operation has been completed. Below is the processing result. Process: addition; Successful results: 200; File name: hoge.csv.”

Thus, when the time required before the administrator may be notified of the result of the user batch management operation is shorter than the threshold value, the administrator may check the result of the user batch management operation on the administrator function screen 1000, for example. On the other hand, if the required time is longer than the threshold value, the administrator may check the operation result by email.

In certain embodiments, the message indicating the result of the user batch management operation may also include information on an error that has occurred. Also, in the case where the message indicating the acceptance of the user batch management operation includes information on the required processing time, the information management service application 61 may notify the administrator of a delay by email when the user batch management operation is not yet completed even after the elapse of the required processing time indicated.

<<Determination of User to be Notified>>

After executing the user batch management operation, the administrator may have to notify a relevant user of the result of the user batch management operation depending on the processing item (e.g., user name, password) or the process type (e.g., addition, change) of the user batch management operation, and this may be a further burden on the administrator. Thus, the service providing system 50 of the present embodiment is configured to determine a relevant user to be notified of the result of the user batch management operation, and notify the relevant user of the user batch management operation result.

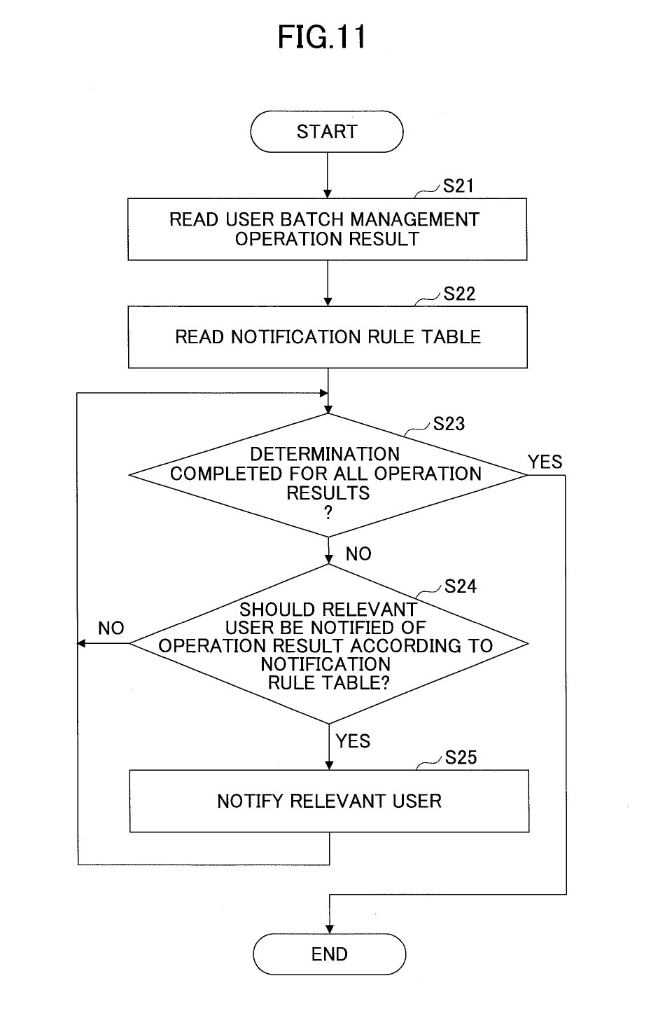

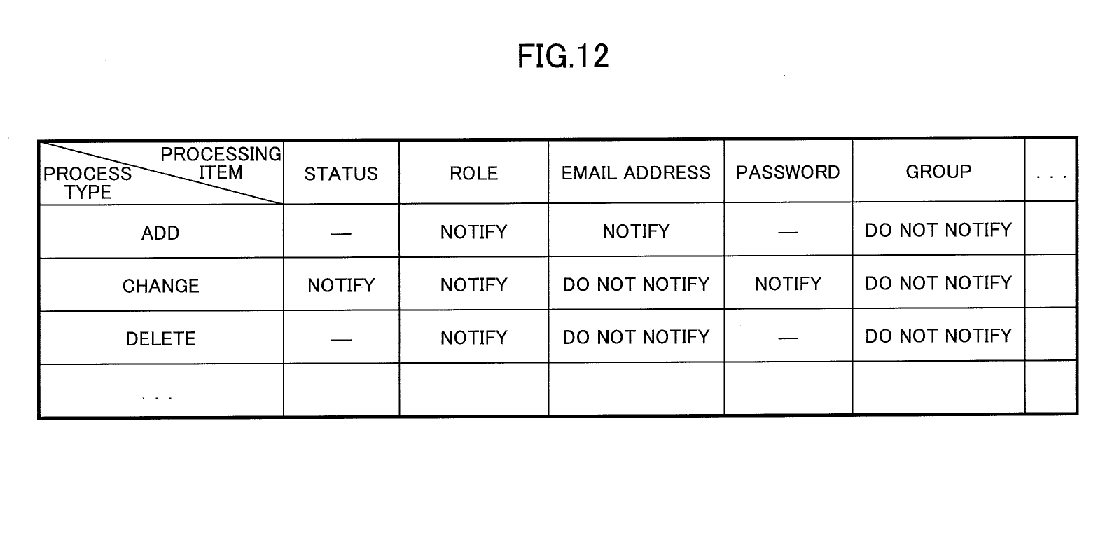

FIG. 11 is a flowchart illustrating exemplary process steps of a determination process for determining a user to be notified of a user batch management operation result. In step S21, the information management service application 61 reads the user batch management operation result. Then, in step S22, the information management service application 61 reads a notification rule table such as that illustrated in FIG. 12, for example, which is to be used in the process of determining a user to be notified.

FIG. 12 illustrates an exemplary configuration of the notification rule table. The notification rule table is used to determine whether to notify a relevant user subject to the user batch management operation of the user batch management operation result. The notification rule table illustrated in FIG. 12 indicates a corresponding determination result (NOTIFY/DO NOT NOTIFY) for each case depending on the processing item that is subject to the user batch management operation and the process type of the user batch management operation.

The notification rule table may be set up taking into account the use policy and management of users in the system. For example, according to the notification rule table of FIG. 12, in the case of implementing a role change as the user batch management operation, “NOTIFY” is indicated at the corresponding location within the notification rule table for “role” as the processing item and “change” as the process type. Accordingly, the information management service application 61 may refer to the notification rule table of FIG. 12 to determine that the relevant user subject to such user batch management operation is to be notified of the execution result of the user batch management operation.

In step S23, the information management service application 61 determines whether the determination of whether to notify a relevant user of a user batch management operation result has been completed with respect to all user batch management operation results.

If the determination of whether to notify a relevant user of a user batch management operation result has been made with respect to all the user batch management operation results, the information management service application 61 ends the determination process of FIG. 11. If the determination of whether to notify a relevant user of a user batch management operation result is not yet completed for all the user batch management operation results, the information management service application 61 proceeds to step S24 to determine whether the execution result of a given user batch management operation should be notified to a relevant user.

In step S24, the information management service application 61 determines whether to notify a relevant user of a user batch management operation result that has not yet been subject to the determination process. If it is determined that the user batch management operation result should be notified to the relevant user, the information management service application 61 notifies the relevant user of the operation result in step S25. Note that the process steps S23-S25 are repeated until the determination of whether to notify a relevant user of a user batch management operation has been completed with respect to all user batch management operation results.

According to an aspect of the present embodiment, after the administrator implements a user batch management operation, a relevant user to be notified of the operation result may be automatically determined, and the relevant user may be automatically notified of the user batch management operation result. In this way, the burden on the administrator may be reduced.

### SUMMARY

In the system 1 according to the present embodiment, when the time required before the administrator may be notified of the result of an operation on management information is longer than a predetermined time period, the administrator does not have to wait for the operation result to be displayed on the webpage screen providing the batch management function and may instead be notified of the operation result by email.

Also, in the system 1 according to the present embodiment, after the administrator implements a user batch management operation, a relevant user to be notified of the operation result may be automatically determined, and the relevant user may be automatically notified of the user batch management operation result.

In this way, the system 1 of the present embodiment may reduce the burden on the administrator that requests an operation to be implemented on management information.

Although the present invention has been described above with reference to certain preferred embodiments, the present invention is not limited to these embodiments, and numerous variations and modifications may be made without departing from the scope of the present invention.

The present application is based on and claims the benefit of priority of Japanese Patent Application No. 2012-198651 filed on Sep. 10, 2012, the entire contents of which are hereby incorporated by reference.

What is claimed is:

1. An information processing apparatus comprising:
a receiving part that receives, via a network, a processing request for a process to be performed on management information from a terminal apparatus;
an execution time estimating part that estimates an execution time of the process to be performed on the management information; and
a selection part that selects a notification method for notifying an execution result of the process to be performed on the management information based on a comparison result of comparing the estimated execution time with a predetermined threshold value.

2. The information processing apparatus as claimed in claim 1, wherein
when the estimated execution time is shorter than the predetermined threshold value, the selection part selects as the notification method a first method that includes notifying the execution result of the process on the management information after the process on the management information has been executed; and
when the estimated execution time is longer than the threshold value, the selection part selects as the notification method a second method that includes providing notification of the acceptance of the processing request for the process to be performed on the management information before executing the process on the management information, and notifying the execution result of the process on the management information by electronic mail after the process on the management information has been executed.

3. The information processing apparatus as claimed in claim 2, wherein
as the method of providing notification of the acceptance of the processing request for the process to be performed on the management information, the selection part selects a method that includes displaying the notification of the acceptance of the processing request for the process to be performed on the management information on a screen that accepts the processing request for the process to be performed on the management information from the terminal apparatus.

4. The information processing apparatus as claimed in claim 1, further comprising:
a determination part that determines whether to notify a relevant user subject to the process on the management information of the execution result of the process on the management information based on a notification rule table for determining a user to be notified of the execution result of the process on the management information according to a processing item of the management information that is subject to the process on the management information and a process type of the process on the management information.

5. The information processing apparatus as claimed in claim 4, further comprising:
a notification part that notifies the execution result of the process on the management information to the relevant user subject to the process on the management information when the determination part determines that the relevant user is to be notified of the execution result of the process on the management information.

6. The information processing apparatus as claimed in claim 1, wherein
a file describing the process to be performed on the management information is used to accept the processing request for the process to be performed on the management information in a batch.

7. A method of controlling an information processing apparatus to perform the steps of:
receiving, via a network, a processing request for a process to be performed on management information from a terminal apparatus;
estimating an execution time of the process to be performed on the management information; and
selecting a notification method for notifying an execution result of the process to be performed on the management information based on a comparison result of comparing the estimated execution time with a predetermined threshold value.

8. The method as claimed in claim 7, further controlling the information processing apparatus to perform the step of:
determining whether to notify a relevant user subject to the process on the management information of the execution result of the process on the management information based on a notification rule table for determining a user to be notified of the execution result of the process on the management information according to a processing item of the management information subject to the process on the management information and a process type of the process on the management information.

9. A system in which a terminal apparatus and an information processing apparatus are connected via a network, the system comprising:
a receiving part that receives a processing request for a process to be performed on management information;
an execution time estimating part that estimates an execution time of the process to be performed on the management information; and
a selection part that selects a method of transmitting an execution result of the process to be performed on the management information from the information processing apparatus to the terminal apparatus based on a comparison result of comparing the estimated execution time with a predetermined threshold value.

10. The system as claimed in claim 9, further comprising:
a determination part that determines whether to notify a relevant user subject to the process on the management information of the execution result of the process on the management information based on a notification rule table for determining a user to be notified of the execution result of the process on the management information according to a processing item of the management information subject to the process on the management information and a process type of the process on the management information.
